(19) United States
(12) Patent Application Publication
(10) Pub. No.: US 2011/0021098 A1
(43) Pub. Date: Jan. 27, 2011

(54) Finishing of Substrates

(75) Inventors: Frank Tabellion, Saarbrücken (DE); Klaus Steingröver, Saarbrücken (DE); Peter Waeber, Arbon (CH); Roland Lottenbach, Zelg/Wolfhalden (CH)

Correspondence Address: SHOEMAKER AND MATTARE, LTD, 10 POST OFFICE ROAD - SUITE 100, SILVER SPRING, MD, 20910, US

(73) Assignees: Bühler Partec GmbHü, Saarbrücken (DE); Schoeller Textil AG, Sevelen (CH)

(21) Appl. No.: 12/514,279

(22) PCT Filed: Oct. 23, 2007
(86) PCT No.: PCT/CH2007/000519

§ 371 Date: Oct. 8, 2010

(30) Foreign Application Priority Data
Nov. 10, 2006 (DE) 10 2006 053 326.7

(51) Int. Cl. B32B 33/00; B32B 17/06; B32B 15/04; B32B 21/04; B32B 9/04; D06M 15/643; B05D 3/00; B05D 3/06; B02C 19/00

(52) U.S. Cl. 442/80; 428/426; 428/457; 428/537.1; 428/411.1; 428/446; 428/375; 442/79; 442/91; 252/8.61; 427/387; 427/551; 241/30

(57) ABSTRACT

A method is described for manufacturing a finish formulation for the hydrophobic and/or oleophobic finishing of surfaces, comprising a dispersant incorporating dispersed, activated particles with hydrophobic and/or oleophobic surface groups and a binder, in which particles with hydrophobic and/or oleophobic surface groups are comminuted in the dispersant for activation, and the binder is added before or after activation.

The obtained finish formulation clearly improves the physical properties of a transparent finish while maintaining very good hydrophobing/oleophobing. It is suitable for finishing all surfaces, in particular for finishing fibers or textiles of all kinds.

The invention relates to a method for manufacturing a finish formulation, the formulation for finishing substrates manufactured in this way, as well as the finished substrate with a hydrophobic and/or oleophobic finish or coating. The substrates to be finished include both hard and soft substrates, but especially fibers or textiles.

Gently cleaning surfaces, avoiding adhesions or improving dirt removal or reducing resoiling of surfaces is associated with significant economic and technical importance in the most varied of applications. In recent years, considerable efforts have hence been undertaken to make surfaces hydrophobic and/or oleophobic with specific finishes. Such coatings, which are also referred to as “finish layer” or “finish, are used in numerous articles of daily use as so-called “anti-stick layer” or “easy-to-clean layer”.

Examples here include metal substrates, e.g., frying pans or wires, along with substrates consisting of polymer materials, e.g., polyester, polyamide, cotton or sheep's wool, in particular in the form of fibers or textiles.

It is generally known that in particular two functional principles can be applied in generating such surfaces, specifically the Lotus effect, which is brought about via surface structuring, so that dirt particles adhere to the surface of a water drop better than to the structured surface itself, and can thus be easily rinsed away, and the easy-to-clean effect, which is caused by using alkyl and/or fluorine based or alkyl and/or fluorine containing formulations, and results in low-energy surfaces, making it hard for dirt particles to adhere, and thereby making the cleaning process easier.

EP-A-587667 describes a coating composition based on inorganic polycondensates for manufacturing anti-stick coatings. The hydrophobic/oleophobic nature is created by using silanes having a perfluorinated alkyl group, which form a low-energy surface. These systems are characterized by an overall high mechanical stability, but not relative to the perfluorinated functional layer. The anti-stick properties completely disappear after a relatively few cycles in the Taber test, for example. The hydrophobic/oleophobic nature is also very adversely affected given prolonged content with water vapor or frequent contact with detergents or cleansers, which is synonymous with the low chemical stability of the functional layer.

Fiber materials, in particular consumer textiles in the form of flat materials, are given an oil- and water-repellant finish via the application of fluorine-containing polymers. The polymers are mostly perfluorinated systems, which are applied to the textile as aqueous dispersions. U.S. Pat. No. 4,742,140, U.S. Pat. No. 5,725,789 and U.S. Pat. No. 3,491,169 describe the use of perfluorinated residue-containing acrylates for the treatment of textiles. U.S. Pat. No. 5,019,428 describes the use of perfluorinated polyurethanes. U.S. Pat. No. 4,265,585 and U.S. Pat. No. 4,401,780 describe mixtures of various perfluorinated polymers, which are suitable for the treatment of flat textile materials.

The disadvantage to these systems is that the properties are not optimal relative to the oil- and water-repellant finish of textile materials. In addition, the desired effect is most often achieved only with a very high layer thickness on the textile, if at all. However, the biggest disadvantage to these systems lies in the excessively low mechanical stability and associated loss in effect owing to abrasion in both the wet and dry state.

In addition to inorganic monomers and polymers, increasing use has in recent years also been made of organic and inorganic solids, including nanoparticles, for the hydrophobic/oleophobic finish of substrates.

For example, DE-A-102004035654 describes a method for finishing absorptive materials using inorganic solids, e.g., pyrogenic silica modified with dimethylsiloxane groups. However, the textiles finished with this method often exhibit inadequate oleophobic properties. The finish is also not completely transparent. Activating the used active ingredients beforehand, in particular the nanoparticles, is not described.

EP-A-1268919 describes a host-guest system based on hydrophobic additives for manufacturing textile finishes with pronounced hydrophobic surface characteristics. The used hydrophobic active ingredients here self-organize to form a gradient, wherein the guest becomes enriched on the surface in the completed textile finish, which leads to hydrophobization.

The disadvantages to this system include a) slight oleophobization, in particular when using active ingredients like wax or hydrophobized silicon dioxide and/or b) low stability under a mechanical load both in the wet and dry states. The washing resistance, in particular the long-term washing resistance, could also stand improvement. Activating the used active ingredients beforehand, in particular the nanoparticles, is not described.

WO-A-2006/007754 proposes that perfluorinated nanoparticles be used to impart a water- and oil-repellant finish to textile fibers and flat materials. While this system is distinguished by a improved oleophobization by comparison to the systems described in EP-A-1268919, it has comparable disadvantages with respect to mechanical stability in a wet and dry state and long-term washing resistance. In addition, no completely transparent finish is obtained. Activating the used active ingredients beforehand, in particular the nanoparticles, is not described.

Therefore, the object became one of providing a finish formulation that does not exhibit the disadvantages cited above, and can be used to finish surfaces with a very good hydrophobing/oleophobing or anti-sick effect while simultaneously maintaining a high transparency. In addition, the mechanical properties, e.g., abrasion resistance and washing resistance, are to be improved by comparison to known finishes.

The object could surprisingly be achieved using a method for manufacturing a finish formulation for the hydrophobic and/or oleophobic finishing of surfaces, comprising a dispersant incorporating dispersed, activated particles with hydrophobic and/or oleophobic surface groups and a binder, in which particles with hydrophobic and/or oleophobic surface groups are comminuted in the dispersant for activation, and the binder is added before or after activation.

Consequently, the present invention also encompasses a finish formulation for the hydrophobic and/or oleophobic finishing of surfaces, which comprises a dispersant, activated particles dispersed therein with hydrophobic and/or oleophobic surface groups and a binder.

According to the invention, substrates or surfaces can be treated with the finish formulation, which exhibits a dispersant; a binding phase; as well as an activated hydrophobic and/or oleophobic active ingredient (particles) in a dispersed form, so as to apply a layer comprised of the formulation on the substrate and then harden it.

It was here surprisingly discovered that activating the dispersed active ingredient contained in the formulation clearly improved the physical properties of a transparent finish while retaining a very good hydrophobization/oleophobization. The invention will be described in detail below.

In the method according to the invention for manufacturing a finish formulation for surfaces, one or more sorts of particles with hydrophobic and/or oleophobic surface groups are comminuted in a dispersant in order to activate the particles that exert a hydrophobic and/or oleophobic effect.

The particles are solid particles or particles consisting of any suitable material desired. In the following, the terms particles and particles will be used interchangeably. For example, the particles can be organic, even polymer, e.g., plastic, or inorganic, wherein inorganic particles are preferred. Examples of organic particles include dendrimers, glucanes or cyclodextrins, which can contain metal atoms in complex form, if necessary. Examples of inorganic particles are particles of an element, an alloy or element compound. The inorganic particles preferably consist of compounds of metals or semi-metals, e.g., Si or Ge, or boron, wherein metal or semi-metal oxides are especially preferred, including hydrated oxides, oxide hydroxides or hydroxides.

Examples for particles of an element are particles consisting of carbon, such as soot or activated carbon, a semi-metal, such as silicon (including technical Si, ferrosilicon and pure silicon) or germanium, or a metal such as iron (also steel), chromium, tin, copper, aluminum, titanium, gold and zinc. Examples for particles of an alloy can include particles consisting of bronze or brass.

Examples for preferred metal compounds and compounds of semiconductor elements or boron include hydrated oxides, like ZnO, CdO, SiO₂, GeO₂, TiO₂, ZrO₂, CeO₂, SnO₂, Al₂O₃ (in all modifications, including as a corundum, boehmite, AlO(OH), also as aluminum hydroxide), In₂O₃, La₂O₃, Fe₂O₃, Cu₂O, Ta₂O₅, Nb₂O₅, V₂O₅, MoO₃ or WO3, corresponding mixed oxides, e.g., indium-tin-oxide (ITO), antimony-tin-oxide (ATO), fluorine-doped tin oxide (FTO) and those with a perovskite structure, like BaTiO₃ and PbTiO₃, chalcogenides, for example sulfides (e.g., CdS, ZnS, PbS and Ag₂S), selenides (e.g., GaSe, CdSe and ZnSe) and tellurides (e.g., ZnTe or CdTe), halides, like AgCl, AgBr, AgI, CuCl, CuBr, CdI₂ and PbI₂, carbides, like CdC₂ or SiC, silicides, like MoSi₂, arsenides, like AlAs, GaAs and GeAs, antimonides, like InSb, nitrides, like BN, AlN, Si₃N₄ and Ti₃N₄, phosphides, like GaP, InP, Zn₃P₂ and Cd₃P₂, along with carbonates, sulfates, phosphates, silicates, zirconates, aluminates and stannates of elements, in particular of metals or Si, e.g., carbonates of calcium and/or magnesium, silicates, like alkali silicates, talcum, clays (kaolin) or mica, and sulfates of barium or calcium. Other examples for expedient particles include magnetite, maghemite, spinels (e.g., MgO.Al₂O₃), mullite, eskolaite, tialite, SiO₂.TiO₂, or bioceramics, e.g., calcium phosphate and hydroxyapatite. The particles can consist of glass or ceramics.

This case can involve particles that are normally used for manufacturing glass (e.g., borosilicate glass, soda-lime glass or silica glass), glass ceramics or ceramics (e.g., based on oxides SiO₂, BeO, Al₂O₃, ZrO₂ or MgO or the corresponding mixed oxides, electro- and magnetoceramics, like titanates and ferrites, or non-oxide ceramics, like silicon nitride, silicon carbide, boronitride or borocarbide). The particles can also serve as fillers or pigments. Technically important fillers include fillers based on SiO₂, like quartz, cristobalite, tripolite, novaculite, diatomite, silica, pyrogenic silicic acids, precipitated silicic acids and silica gels, silicates, like talcum, pyrophylite, kaolin, mica, muscovite, phlogopite, vermiculite, wollastonite and perlites, carbonates, like calcites, dolomites, chalk and synthetic calcium carbonates, soot, sulfates, like heavy spar and light spar, iron mica, glasses, aluminum hydroxides, aluminum oxides and titanium dioxide, and zeolites. Mixtures of these particles can also be used.

Typical materials for the particles can encompass at least one element selected from C, N, O, S, B, Si, Al, Ti, Zr, Zn, Fe, Ag and Cu, for example. Potentially hydrated silicon oxides and metal oxides are preferred, including oxide-hydroxides and hydroxides, like vanadium, iron, tungsten, titanium, aluminum or zinc oxides or mixtures thereof.

The manufacture of such particles is known. Examples of methods for manufacturing particles include flame pyrolysis, plasma methods, gas-phase condensation methods, colloid techniques, precipitation methods, sol-gel processes, controlled nucleation and growth processes, MOCVD methods and (micro)emulsion methods. These methods are extensively described in the literature.

The usable particles are generally commercially available. Examples for SiO2 particles include commercially available silicic acid products, e.g., silica sols, like Levasiles®, silica sols made by Bayer AG, or pyrogenic silicic acids, e.g., Aeorsil® products made by Degussa. Of course, all particles used as fillers are commercially available. The particle used can be nanoparticles or microparticles, for example.

The particles used as the initial material exhibit hydrophobic and/or oleophobic surface groups. Such hydrophobic and/or oleophobic surface groups are known to the expert. The surface groups preferably encompass organic groups, like aliphatic, alicyclic or aromatic hydrocarbon groups, e.g., linear or branched alkyl, cycloalkyl, aryl, e.g., phenyl or naphthyl, alkaryl, aralkyl and fluorine-containing groups, like fluorinated or perfluorinated aliphatic, alicyclic or aromatic hydrocarbon groups.

Fluorine-containing groups are especially preferred, in particular fluorinated alkyl groups or perfluorinated alkyl groups, which can be interrupted by one or more oxygen atoms, and/or alkyl groups. Especially suited as hydrophobic and/or oleophobic groups are alkyl groups with 3 to 30 or more carbon atoms and alkyl groups with 1 to 30 carbon atoms substituted with at least one fluorine atom, e.g., 1 to 30 fluorine atoms, preferably a fluorinated alkyl group with 3 to 20 C atoms.

Examples of fluorinated alky groups include CF₃CH₂CH₂—, C₂F₅CH₂CH₂—, n-C₆F₁₃CH₂CH₂—, i-C₃F₇OCH₂CH₂CH₂—, n-C₈F₁₇CH₂CH₂— and n-C₁₀F₂₁—CH₂CH₂—. Examples of suitable alkyl groups include propyl, hexyl, heptyl, octyl, nonyl, hexadecyl or dodecyl.

The expert is familiar with the process of modifying the surface of particles with specific groups, in order to impart one or more additional functions to the particles, e.g., with a hydrophobic and/or oleophobic effect in this instance, and he can manufacture or otherwise commercially acquire such surface-modified particles without any problem. Surface-modified particles are generally obtained by reacting the particles with suitable surface modification agents, wherein the surface modification agents can also be added in situ during the manufacture of the particles. The reaction takes place under conditions in which the modification agent bonds to the surface of the particles, e.g., via chemical bonding or interaction. Naturally, the conditions depend on the type of particles and the surface modification agent. While simple stirring at room temperature may be sufficient, energy might also have to be introduced, e.g., via heating. The amount of particle surfaces covered by the modification agents can be controlled, e.g., via the used quantitative proportion of the educts.

The expert knows that the particle surface generally has groups, wherein these surface groups can be functional groups that are generally relatively reactive. For example, the surface of particles accommodates residual valences, like hydroxy groups and oxy groups, e.g., in metal oxide particles, or thiol groups or thio groups, e.g., in metal sulfides, or amino-; amide- and imide groups, e.g., in nitrides.

The surface modification agent with hydrophobic and/or oleophobic group exhibits at least one functional group that can chemically react or interact and bond with reactive groups present on the surface of the particles on the one hand, and at least one hydrophobic and/or oleophobic group on the other. The bond can be established via chemical bonding, e.g., covalent, including coordinative bonds (complexes) or ionic (salt-like) bonds of the functional group with the surface groups of the particles, while interactions can include dipole-dipole interactions, polar interactions, hydrogen bridge bonds and van der Waals interactions. The formation of a chemical bond is preferred. For example, an acid/base reaction, complex formation or esterification can take place between the functional groups of the modification agent and the particle. The expert knows of such surface modification agents, and he can easily select ones that are suitable for the respective particle.

Examples of hydrophobic and/or oleophobic groups are listed above. The functional group encompassing the surface modification agent can involve carbonic acid groups, acid chloride groups, ester groups, nitrile and isonitrile groups, OH groups, alkyl halide groups, SH groups, epoxide groups, anhydride groups, acid amide groups, primary, secondary and tertiary amino groups, Si—OH groups or hydrolysable residues of silanes (Si—X groups described below) or C—H-acid groups, like ss-dicarbonyl compounds. The modification agent can also encompass more than one such functional group, e.g., in amino acids or EDTA.

Examples of suitable surface modification agents hence are mono- and polycarbonic acids, corresponding acid anhydrides, acid chlorides, esters and acid amides, alcohols, alkyl halides, amino acids, imines, nitriles, isonitriles, epoxy compounds, mono- and polyamine, ss-dicarbonyl compounds, silanes and metal compounds, which have a functional group that can react with the surface groups of the particles, which each have a hydrophobic and/or oleophobic group. Especially preferred for use as modification agents with a hydrophobic and/or oleophobic group are silanes, carbonic acids, carbonic acid derivatives, like acid anhydrides and acid halides, in particular acid chlorides, alcohols, alkyl halides, like alkyl chlorides, alkyl bromides and alkyl iodides, wherein the alkyl residue can be substituted, in particular with fluorine. One or more modification agents can be used.

Suitable hydrophobic and/or oleophobic groups include the aforementioned, in particular long-chain aliphatic hydrocarbon groups, e.g., with 1 to 30 or more carbon atoms, in particular alkyl groups, aromatic groups, or groups exhibiting at least one fluorine atom, wherein these are preferably hydrocarbon groups, in particular alkyl residues, with 1 to 20 or more carbon atoms and 1 to 41 fluorine atoms.

Preferred surface modification agents are hydrolysable silanes with at least one non-hydrolysable hydrophobic and/or oleophobic group. Especially preferred here are hydrolysable silanes that exhibit at least one non-hydrolysable group, which is hydrophobic and/or oleophobic, in particular a group that contains at least one fluorine atom (fluorosilanes) or a long-chain aliphatic hydrocarbon group, e.g., with 1 to 30 carbon atoms, preferably an alkyl group, or an aromatic group.

Suitable hydrolysable silanes with a hydrophobic and/or oleophobic group have the general formula

RₐSiX₍₄₋ₐ₎ (I)

wherein R is the same or different, and represents a non-hydrolysable residue, wherein at least one group R is a hydrophobic and/or oleophobic group, X is a hydrolysable group or OH, and has the value 1, 2 or 3, preferably 1 or 2.

The hydrolysable group X can be hydrogen or halogen (F, Cl, Br or I), alkoxy (preferably C₁₋₆-alkoxy, e.g., methoxy, ethoxy, n-propoxy, i-propoxy and butoxy), aryloxy (preferably C₆₋₁₀-aryloxy, e.g., phenoxy), acyloxy (preferably C₁₋₆-acyloxy, e.g., acetoxy or propionyloxy), alkyl carbonyl (preferably C₂₋₇-alkyl carbonyl, e.g., acetyl), amino, monoalkyl amino or dialkyl amino with preferably 1 to 12, in particular 1 to 6 carbon atoms in the alkyl group(s).

The non-hydrolysable residue R can be alkyl (preferably C1-30-alkyl, e.g., methyl, ethyl, n-propyl, isopropyl, n-butyl, s-butyl and t-butyl, pentyl, hexyl or cyclohexyl), alkenyl (preferably C₂₋₆-alkenyl, e.g., vinyl, 1-propenyl, 2-propenyl and butenyl), alkinyl (preferably C₂₋₆-alkinyl, e.g., acetylenyl and propargyl) and aryl (preferably C₆₋₁₀-aryl, e.g., phenyl and naphthyl), wherein at least one group R is a hydrophobic and/or oleophobic group.

The hydrophobic and/or oleophobic group R can be a long-chained aliphatic hydrocarbon group, e.g., with 1 to 30 C atoms. The long-chained aliphatic hydrocarbon group preferably involves an alkyl group. Silanes having formula (I) can also be used, if necessary, wherein R is a possibly substituted aromatic group. A preferred silane having formula (I) only has one non-hydrolysable group, specifically the hydrophobic and/or oleophobic group R (a=1).

Examples for hydrolysable silanes with a long-chained aliphatic hydrocarbon group are hexadecyl trimethoxysilane (HDTMS), dodecyl triethoxysilane and propyl trimethoxysilane.

The hydrophobic and/or oleophobic group R in formula (I) is especially preferably a hydrocarbon group substituted with at least one fluorine atom. These silanes are also referred to as fluorosilanes. Therefore, especially preferred hydrolysable silane compounds have the general formula

Rf(R)_{b}SiX_{(3-b)} (II)

wherein X and R are defined as in formula (I), Rf is a non-hydrolysable group that exhibits 1 to 41 fluorine atoms bound to carbon atoms, which are preferably separated from Si by at least two atoms, preferably an ethylene, propylene, ethylene oxy or propylene oxy group, and b is 0, 1 or 2, preferably 0 or 1. R is preferably an alkyl group, in particular C₁₋₄-alkyl like methyl or ethyl. The Rf groups preferably contain 3 to 25, and in particular 3 to 21, fluorine atoms, which are bound to aliphatic (including cycloaliphatic) carbon atoms. Rf is preferably a fluorinated alkyl group with 3 to 20 C atoms, preferably interrupted by one or more oxygen atoms.

Examples for Rf include CF₃CH₂CH₂—, C₂F₅CH₂CH₂—, n-C₆F₁₃CH₂CH₂—, i-C₃F₇OCH₂CH₂CH₂—, n-C₈F₁₇CH₂CH₂— and n-C₁₀F₂₁—CH₂CH₂—. Examples of usable fluorosilanes are CF₃CH₂CH₂SiCl₂(CH₃), CF₃CH₂CH₂SiCl(CH₃)₂, CF₃CH₂CH₂Si(CH₃)(OCH₃)₂, C₂F₅CH₂CH₂—SiZ₃, n-C₆F₁₃CH₂CH₂—SiZ₃, n-C₈F₁₇CH₂CH₂—SiZ₃, n-C₁₀F₂₁—CH₂CH₂—SiZ₃ with (Z═OCH₃, OC₂H₅ or Cl); i-C₃F₇O—CH₂CH₂CH₂—SiCl₂(CH₃), n-C₆F₁₃CH₂CH₂—Si(OCH₂CH₃)₂, n-C₆F₁₃CH₂CH₂—SiCl₂(CH₃), n-C₆F₁₃CH₂CH₂—SiCl(CH₃)₂, and (3,3,4,4,5,5,6,6,7,7,8,8,8-tridecafluorooctyl)triethoxysilane (FTS).

Other specific examples for surface-modification agents with a hydrophobic and/or oleophobic group include 1H,1H-pentadecafluorooctanol, octanol, nonanol, decanol, heptadecafluorononanic acid, stearic acid, heptafluorobutyric acid chloride, hexanic acid chloride, hexanic acid methyl ester, perfluoroheptanic acid methyl ester, perfluorooctanic acid anhydride, hexanic acid anhydride, 1,1,1,2,2,3,3-heptafluoro-7,7-dimethyl-4,6-octandione, hexyl chloride and nonafluorobutyl chloride.

The surface modification agent preferably exhibits a molecular weight not exceeding 1,500, more preferably not exceeding 1,000; however, modification agents with a higher molecular weight can also be used.

In addition to having its surface modified with a hydrophobic and/or oleophobic group, the particles can also be modified with one or more additional group son the surface to impart one or more additional functions to the particles. These additional groups preferably exhibit a functional group, via which polymerization, condensation or cross-linking reactions can take place, among others. These additional groups can be applied to the particles in the same way as the hydrophobic and/or oleophobic groups by means of a surface modification agent. Therefore, everything stated above relative to the surface modification agent and binding to the particles for the hydrophobic and/or oleophobic group applies in precisely the same way to modification with an additional group, except that another additional group is applied to the particles instead of a hydrophobic and/or oleophobic group. Surface modification with these additional groups can take place before, after or simultaneously with the hydrophobic and/or oleophobic modification.

Examples for such additional groups, preferably ones with a functional group that can be applied to the particle surfaces, include short-chained alkyl-, alkenyl-, like vinyl- or allyl-, epoxy-, hydroxy-, ether-, amino-, monoalkyl amino-, dialkyl amino, possibly substituted anilino-, amide-, carboxy-, acryl-, acryloxy-, methacrylate-, methacryloxy-, silyl-, mercapto-, cyano-, alkoxy-, isocyanato-, aldehyde-, alkyl carbonyl-, acid anhydride- and phosphoric acid groups.

Examples for suitable surface modification agents include the aforementioned, but with another additional group other than a hydrophobic and/or oleophobic group. For example, use can be made of silanes having general formula (I) without a hydrophobic and/or oleophobic group. For example, use can be made of a silane having formula (I), in which at least one group R encompasses one of the aforementioned functional groups instead of a hydrophobic and/or oleophobic group, which can be bound to the silicon atom via alkylene-, alkenylene- or arylene-bridge groups that can be interrupted by oxygen or NH groups. The bridge groups contain between 1 and 18 carbon atoms, for example.

Specific examples for corresponding silanes include γ-glycidyl oxypropyl trimethoxysilane (GPTS), γ-glycidyl oxypropyl triethoxysilane (GPTES), 3-aminopropyle trimethoxysilane (APTS), 3-(meth)acryloxypropyl triethoxysilane or 3-(meth)acryloxypropyl trimethooxysilane. Other specific examples for surface modification agents that can be used to introduce additional groups include saturated or unsaturated mono- and polycarbonic acids, e.g., formic acid, acrylic acid, methacrylic acid or crontonic acid, mono- and polyamines, like methyl amine, or ethylene diamine, ss-dicarbonyl compounds, like acetyl acetone, or amino acids.

The particles with hydrophobic and/or oleophobic surface groups are dispersed in a dispersant. The expert can use any dispersant known to him as the dispersant. The expert can easily select the dispersant suitable for the respectively used surface modified particle. For example, it can be one used during particle surface modification.

Depending on the particles to be dispersed, the suitable dispersant is selected from water, in particular de-ionized water, or organic solvents; however, inorganic solvents, like carbon disulfide, are also conceivable. Both polar and non-polar and aprotic solvents are suitable as the organic dispersant. Examples include alcohols, e.g., aliphatic and alicyclic alcohols with 1 to 8 carbon atoms (in particular methanol, ethanol, n- and i-propanol, butanol, octanol, cyclohexanol), ketones, e.g., aliphatic and alicyclic ketones with 1 to 8 carbon atoms (in particular acetone, butanone and cyclohexanone), esters, e.g., acetic acid ethyl ester and glycol ester, ether, e.g., diethyl ether, dibutyl ether, anisole, dioxane, tetrahydrofurane and tetrahydropyrane, glycol ethers, like mono-, di-, tri- and polyglycol ether, glycols, like ethylene glycol, diethylene glycol and propylene glycol, amides and other nitrogen compounds, e.g., dimethyl acetamide, dimethyl formamide, pyridine, N-methylpyrrolidine and acetonitrile, sulfoxides and sulfones, e.g., sulfolane and dimethyl sulfoxide, nitro compounds, like nitrobenzene, halogen hydrocarbons, like dichloromethane, chloroform, tetrachlorocarbon, tri-, tetrachloroethene, ethylene chloride, chlorofluorocarbons, aliphatic, alicyclic or aromatic hydrocarbons, e.g., with 5 to 15 carbon atoms, e.g., pentane, hexane, heptane and octane, cyclohexane, benzenes, petrol ether, methyl cyclohexane, decalin, terpene solvents, benzene, toluene and xylols. Of course, mixtures of such dispersants can also be used.

Preferably used organic dispersants are aliphatic and alicyclic alcohols, like ethanol, n- and i-propanol, glycols like ethylene glycol and butyl glycol, and aliphatic, alicyclic and aromatic hydrocarbons, like hexane, heptane, toluene and o-, m- and p-xylol.

In one variant of the method according to the invention, the used binder described below can simultaneously assume the function of the dispersant, so that the same compound can be used for the dispersant and binder.

All binders known to the expert can be used as the binder. Combinations of different binders can also be used. The binder can also be referred to as a binding phase. The binders conventionally encompass the corresponding pre-stages, which only begin to exert their binder effect after polymerization, condensation or hardening reactions. Examples of binders include organic monomers, oligomers or prepolymers and/or polymers, hydrolysable inorganic compounds, which can exhibit at least partially non-hydrolysable organic groups or inorganic or organically modified inorganic condensates or hydrolysates of these hydrolysable compounds or combinations thereof. For example, the binder can encompass at least one element selected from C, Si, B, P, Al, Zr and Ti. The binder preferably encompasses at least one functional group. Examples for the functional group include carbon-carbon double bonds, like vinyl and allyl, alkinyl, alkoxycarbonyl, epoxy, carboxy, carbonyl, amino, imino, amido, acryl-, acryloxy-, methacryl-, methacryloxy-, acrylate, methacrylate, possibly blocked isocyanate, free isocyanate, mercapto-, cyano-, aldehyde-, nitriles, hydroxy, alkoxy, silanol groups and thiol. The used binder is preferably polymerizable, condensable or cross-linkable, i.e., it has functional groups that permit polymerization, polycondensation or cross-linking.

Binders can be present in the form of dispersions or emulsions. The expert can use known organic polymers as the binder, e.g., polyacrylic acid, polymethacrylic acid, polyacrylates, polymethacrylates, polyolefins, e.g., polybutadiene, free and blocked polyisocyanates, e.g., oxime-blocked polyisocyanates, polystyrene, polyamide, polyimide, polyvinyl compounds, like polyvinyl ether, polyvinyl chloride, polyvinyl alcohol, polyvinyl butyral, polyvinyl acetate and corresponding copolymers, e.g., poly(ethylene vinyl acetate), polyester, including unsaturated polyester, e.g., polyethylene terephthalate or polydiallyl phthalate, polyarylates, polyexetanes, polycarbonates, polyether, e.g., polyoxymethylene, polyethylene oxide or polyphenylene oxide, polyether ketones, polysulfones, polyepoxides, artificial resins and fluoropolymers, e.g., polytetrafluoroethylene. Suitable fluoropolymers include fluorocarbon resins with fluorinated or perfluorinated C₄-C₁ groups or side chains. However, pre-stages thereof can also be used, i.e., the corresponding organic monomers, oligomers or prepolymers of the mentioned polymers.

Possible binders also include cross-linkers alone or in combination with other binders, in particular those that can react with cellulose (cellulose cross-linkers). Cross-linkers are often used in finish formulations for textiles, e.g., for a “wash and wear” finish. Easy-care finish and commercially available cross-linkers also include the Knittex® and Lyofix® products made by Huntsman. Self-cross-linkers, semi-reactant cross-linkers or reactant cross-linkers are also possible. Examples include methylol urea products, like dimethylol urea (DMU) and etherified DMU, melamine cross-linkers, like melamine and N-methylol melamines, cross-linkers based on urone or triazone, tetramethylol acetylene diurea, dimethylol ethylene urea, possibly modified dimethylol dihydroxyethylene urea, dimethylol propylene urea, dimethylol-5-hydroxypropylene urea, 4-methoxy-5,5-dimethyl-N,N′-dimethylol propylene urea, carbamates, possibly modified dimethyl dihydroxyethylene urea, acetales and semi-acetales and sulfonium compounds.

Possible binders based on purely inorganic polycondensates include hydrolysable parent compounds, in particular metal alkoxides or alkoxysilanes, or hydrolyzates or condensates formed from them. Binders based on organically modified inorganic polycondensates, preferably polyorganosiloxanes, can also include hydrolysable parent compounds, in particular metal alkoxides or alkoxysilanes, or hydrolysates or condensates formed from them, wherein at least a portion of the used hydrolysable compounds encompasses a non-hydrolysable organic residue. The organically modified inorganic polycondensates or pre-stage thereof can also contain organic residues with functional groups that enable a polymerization or cross-linking, e.g., the functional groups mentioned above for the organic binder.

Inorganic or organically modified inorganic binders or pre-stages thereof can be manufactured in particular via hydrolysis and condensation of hydrolysable parent compounds, e.g., according to the sol-gel process. The hydrolysable parent compounds involve element compounds with hydrolysable groups, wherein at least a portion of these compounds might also encompass non-hydrolysable groups, or oligomers thereof.

The hydrolysable parent compounds that do not encompass any non-hydrolysable group and are used for manufacturing the purely inorganic polycondensates or pre-stages thereof include compounds of at least one element M from the primary groups III, IV and V and/or the secondary groups II to V of the periodic table of elements. The element preferably is a metal or semi-metal, including Si and B. These are preferably hydrolysable compounds of Si, Al, B, Sn, Ti, Zr, V or Zn or mixtures of two or more of these elements. Other hydrolysable compounds can also be used, e.g., those comprised of metals from the primary groups I and II of the periodic table (e.g., Na, K, Ca and Mg) and the secondary groups VI to VIII of the periodic table (e.g., Mn, Cr, Fe and Ni). Hydrolysable compounds of lanthanides can also be used.

Organically modified inorganic binders are manufactured using one or more hydrolysable compounds, comprising at least one non-hydrolysable organic group, alone or in combination with the hydrolysable compounds described above without non-hydrolysable groups. Hydrolysable organosilanes or oligomers thereof are preferably used as the hydrolysable parent compound, which exhibits at least one non-hydrolysable group.

Examples of usable hydrolysable silanes with non-hydrolysable groups include silanes having the general formula RₐSiX₍₄₋ₐ₎, wherein the residues R are identical or different, and represent non-hydrolysable groups, the residues X are identical or different, and signify hydrolysable groups or hydroxyl groups, and a is 1, 2 or 3, preferably 1, or an oligomer derived from it.

The general formula includes the hydrolysable groups X, which can be identical or different, e.g., hydrogen or halogen (F, Cl, Br or I), alkoxy (preferably C₁₋₆-alkoxy, e.g., methoxy, ethoxy, n-propoxy, i-propoxy and butoxy), aryloxy (preferably C₆₋₁₀-aryloxy, e.g., phenoxy), acyloxy (preferably C₁₋₆-acyloxy, e.g., acetoxy or propionyloxy), alkyl carbonyl (preferably C₂₋₇-alkyl carbonyl, e.g., acetyl), amino, monoalkyl amino or dialkyl amino with preferably 1 to 12, in particular 1 to 6 carbon atoms. Preferred hydrolysable residues are halogen, alkoxy groups and acyloxy groups. Especially preferred hydrolysable residues are C₁₋₄ alkoxy groups, in particular methoxy and ethoxy.

The non-hydrolysable residues R, which can be identical or different, can be non-hydrolysable residues R with a functional group that enables cross-linking, for example, or non-hydrolysable residues R without a functional group.

The non-hydrolysable residue R without a functional group can be alkyl (preferably C₁₋₈-alkyl, like methyl, ethyl, n-propyl, isopropyl, n-butyl, s-butyl and tert.-butyl, pentyl, hexyl, octyl or cyclohexyl), aryl (preferably C₆₋₁₀-aryl, e.g., phenyl and naphthyl) as well as corresponding alkyl aryls and aryl alkyls. The residues R and X can be exhibit one or more common substituents, e.g., halogen or alkoxy.

Special examples for functional groups that enable cross-linking include the epoxide-, hydroxy-, ether-, amino-, monoalkyl amino-, dialkyl amino, possibly substituted anilino-, amide-, carboxy-, vinyl-, allyl-, alkinyl-, acryl-, acryloxy-, methacryl-, methacryloxy-, mercapto-, cyano-, alkoxy-, isocyanato-, aldehyde-, alkyl carbonyl-, acid anhydride- and phosphoric acid group. These functional groups are bound to the silicon atom via alkylene-, alkenylene- or arylene-bridge groups, which can be interrupted by oxygen or NH groups. Examples for non-hydrolysable residues R with vinyl- or alkinyl group include C₂₋₆-alkenyl, e.g., vinyl, 1-propenyl, 2-propenyl and butenyl and C₂₋₆-alkinyl, e.g., acetylenyl and propargyl. The cited bridge groups and any present substituents, as in the case of the alkyl amino groups, are derived from the aforementioned alkyl-, alkenyl- or aryl residues, for example. Naturally, the residue R can also exhibit more than one functional group.

The inorganic or organically modified inorganic binders from the cited hydrolysable compounds are preferably manufactured or hardened in a sol-gel process with the formation of the hydrolyzates and condensates. In the sol-gel process, hydrolysable compounds are usually hydrolyzed and possibly at least partially condensed with water, if necessary accompanied by acidic or basic catalysis. The hydrolysis and/or condensation reactions result in the formation of compounds or condensates with hydroxy-, oxo groups and/or oxo bridges that serve as pre-stages. Suitably adjusting the parameters, e.g., condensation level, solvent, temperature, water concentration, duration or pH value, makes it possible to obtain a sol suitable as binder. Additional details relating to the sol-gel process are discussed among other places in “Sol-Gel Science—The Physics and Chemistry of Sol-Gel Processing” by C. J. Brinker, G. W. Scherer, Academic Press, Boston, San Diego, New York, Sydney (1990).

If needed, other additives can be introduced into the finish formulation. In particular, these can be additives of the kind used in conventional finish formulations. Examples include wetting agents, thickeners, dispersants, initiators, catalysts, organic or inorganic IR and UV protectants, coupling agents, softeners, antistatic agents, biocides, flame retardants, soluble and particulate dyes, optical brighteners, anti-slip agents, anti-snag agents, laminating agents, organic and inorganic nanoparticles and microparticles, carbon nanotubes. The nanoparticles and microparticles can exhibit no surface groups, or be surface modified with groups, which in particular contain no hydrophobic and/or oleophobic groups. Reference is made to the particle examples described above for examples of nano- and microparticles. Examples include particles of ZnO or Ag to impart microbicidal properties to the finish. Nanoparticles are particles in the nanometer range (average particle size under 1 μm), and microparticles are particles in the micrometer range (average particle size under 1 mm).

Initiators or catalysts can be included to support polymerization, condensation or cross-linking reactions. For example, catalysts are often required for the aforementioned cross-linkers or cellulose cross-liners. Examples include ammonium salt catalysts, such as diammon phosphate, monoammon phosphate, ammonium nitrate, ammonium chloride and ammonium sulfate, metal-salt catalysts, like magnesium chloride, magnesium nitrate, zinc chloride, zinc nitrate, sodium fluoroborate, zinc fluoroborate, organic amine hydrochloride catalysts and acid catalysts.

The constituents of the finish formulation can be mixed together in any sequence desired. The binder and possibly incorporated additives can be mixed before, during or after the activation treatment. In special instances, the used binder can simultaneously serve as the dispersant.

In the method according to the invention, the particles with hydrophobic and/or oleophobic surface groups dispersed in the dispersant are activated via a comminuting treatment. The comminuting treatment takes place in particular in the absence of surface modification agents, which can be bound to the surface of the particles in particular via chemical bonding, e.g., a covalent or coordinative bond (irreversible bonding). By contrast, the presence of substances like wetting agents, which if necessary can enter into an unspecific, non-chemical interaction with the particles (reversible bonding), is generally not disruptive. Their use might even be expedient, e.g., as a dispersing aid. The surface modified particles can be comminuted using any measure known to the expert. For example, the particles can be treated with ultrasound to initiate the comminuting or dispersing process. However, the particles are preferably mechanically comminuted, if possible via shearing and/or impact. Activation via a comminuting treatment preferably takes place in a dispersing machine.

In general, mechanical comminuting takes place in mills, kneaders, cylinder mills, or also in impingement air dispersers, for example. Suitable comminuting machines for mechanical comminuting include homogenizers, turbo agitators, mills with loose grinding implements, like ball, rod, drum, cone, tube, autogenous, planetary, oscillating and agitating mills, shearing roll kneaders, mortar mills, colloid mills and cylinder mills. Activation preferably takes place via wet milling in a mill with auxiliary grinding units, in a roll mill with at least one roll nip, or in an impingement air disperser. Comminuting is preferably executed at room temperature. The duration depends on the type of mixing and used comminuting machine.

For example, mills with loose grinding implements are used. The grinding implements or grinding units include balls, rods or short cylindrical pieces. The container carries out a rotating, planetary or shaking motion, or the grinding units are moved with an agitator. The best mills are agitating ball mills with a moving agitator and grinding balls as the grinding units.

Mills with smaller grinding units are preferably used, making it possible to bring small-dimensioned shearing forces to bear. The size of the grinding unit can vary from 0.1 to 5 mm, for example, preferably from 0.3 to 3 mm, and especially preferred 0.5 to 2 mm. The grinding units usually consist of steel, plastic, hard metal, Al₂O₃, agate, zirconium silicate, ZrO₂, Y—ZrO₂, Ce—ZrO₂, Mg—ZrO₂, glass, SiC, SiN or mixtures of these materials; especially preferred grinding unit materials are stabilized zirconium oxides, zirconium silicate and steel.

Activation or comminuting can also take place in a two or more stage process. For example, milling with grinding units can be preceded by a grinding stage with coarser grinding units, and followed by fine milling. Activation can be supported by the supplying more energy (in addition to the acting mechanical energy), e.g., by way of microwaves and/or ultrasound, wherein these two methods can also be used simultaneously. It is especially preferred that the energy be introduced into the dispersion directly in the comminuting machine, although this can also be done outside the comminuting machine in the circulating product. During activation treatment, enough high energy is introduced to achieve comminuting. The required energy depends to a great extent on the particles to be comminuted, the amount of used dispersant, the used comminuting machine, etc., and can vary within broad limits. The expert can easily set the parameters required for comminuting. For example, it might be best to supply at least 50 kWh of energy per t of dispersion for comminuting treatment, preferably at least 100 kWh/t dispersion, as determined using a ball mill. The dispersion relates to the dispersion being subjected to the comminuting treatment.

Activation according to the invention preferably takes place at a temperature of 0° C. up to the ebullition point of the dispersant, e.g., room temperature (approx. 20° C.) up to the ebullition point of the dispersant. These corresponding operating temperatures can be adjusted by suitably controlling the temperature (cooling) the grinding area of the mill. The process can be carried out both continuously in the single-pass mode, multiple-pass mode (pendulum method) or circulating mode, as well as discontinuously in the batch mode.

Comminuting the particles with hydrophobic and/or oleophobic surface groups surprisingly activates these particles, thereby yielding a finish formulation with improved properties, as demonstrated in the following examples. In particular, the finish formulation can be used to impart a very good hydrophobic or anti-stick effect to surfaces, along with a simultaneously high transparency. In addition, finishes with improved mechanical properties relative to known finishes can be obtained, e.g., wear resistance and washing resistance.

Not wanting to adhere to a single theory, it is assumed that these effects have to do with the fact that comminuting treatment yields smaller particles or fractures, wherein partial surfaces (fractures) are formed on the particles that exhibit no surface modification, and hence are “active”, i.e., reactive. Comminuting may also involve deagglomeration, if the surface-modified particles are present as agglomerates, or encompass such a deagglomeration. Depending on the amount of binder used, the binder can act as an adhesive or binding phase, in which the particles are incorporated into a matrix formed by the binder.

The fractures on the particles formed by comminuting can have different effects. On the one hand, this gives the particles two “sides” with different properties, specifically the surface with the hydrophobic and/or oleophobic groups, and the exposed fractures without these groups. The different properties of the surfaces can lead to a varying compatibility or interaction of the two “sides” with the substrate, binder or matrix formed from it, and the outside environment (air). Depending on the case at hand, this can enrich and/or align the particles in a specific direction in the matrix of the finish formed by the binder, e.g., toward the outside environment, or preferably to the substrate surface. Alignment here refers to the preferred alignment of the “side” with the exposed fracture toward a specific direction, e.g., toward the substrate surface, which stems from a better compatibility of these interfaces, for example. The exposed fracture can be used to bind (“dock”) the particles to a substrate surface, for example, as the result of good compatibility or interactions, which can help improve adhesion. In addition, the exposed fractures of the particles, which do exhibit activated or reactive surface groups, can also form direct chemical bonds with the binder, or preferably with the substrate surface, yielding an even stronger binding.

Also conceivable are scenarios in which the aim is precisely to avoid enriching the particles in a specific direction, e.g., outside environment, so that activation enables a homogeneous distribution in the matrix phase.

According to the invention, the modified surface of the particles can have a specific, dirt-repelling function (oleophobization and/or hydrophobization) on the one hand, while the exposed fracture can have a specific function that binds or “docks” to the substrate surface on the other. This makes it possible to optimize the functionality (dirt repellency, oleophobization, hydrophobization) of the finished substrate surface on the one hand, and the strength of the bond between the particles and substrate on the other hand via the correct choice of particle surface modification and particle core material (composition of particles), in particular for polyester fabric, protein fabric, cellulose fabric and metal fabric, for example.

The particles with hydrophobic and/or oleophobic surface groups contained in the finish formula according to the invention preferably exhibit a specific surface following activation of between 10 and 1,000 m²/g, as determined based on the BET method via nitrogen adsorption. The concentration of activated particles with hydrophobic and/or oleophobic surface groups in the finish formulation can vary within broad limits, but preferably lies between 0.001 and 50% w/w, more preferably between 0.01 and 40% w/w, and particularly preferred between 0.04 and 30% w/w relative to the total weight of the finish formulation, including dispersant. The finish formulation can be a finishing liquor, a coating compound or a lacquer formulation.

The finish formulation according to the invention is particularly well suited for finishing surfaces or substrates with the aim of providing them with a hydrophobic and/or oleophobic finish or coating. While the surfaces or substrates to be finished can be both hard and soft or flexible substrates, it is especially preferred that they be fibers or textiles, in particular in the form of flat materials. Other suitable substrate surfaces that can be finished with a hydrophobic and/or oleophobic finish formulation consist of glass, ceramic, metal, wood or plastic, for example, wherein the surfaces can also be lacquered, primed or pretreated in some other way. Examples include metal substrates, e.g., frying pans, wires or metal fabric, protein fabric, as well as substrates made of polymer materials, including synthetic and natural fibers and fabrics, e.g., polyester, polyamide, cotton, cellulose or sheep's wool, in particular in the form of fibers or textiles.

The substrates or surfaces, in particular the fibers, textiles and flat materials, can be pretreated before applying the finish formulation, e.g., by applying a primer or via some other kind of pretreatment that improves adhesion to the substrate. Examples of suitable primers include acrylates, tannins, potassium antimonyl tartrate, quaternary amine compounds, silanes, polysilazanes, ormocers and nanomers, along with nanoparticles. Other suitable pretreatments involve stripping the surface via treatment with acids or lyes, plasma or corona treatment and plasma oxidation/polymerization.

All current methods that are conventional for finish formulations according to prior art can be used to impart a hydrophobic and/or oleophobic finish to surfaces using the finish formulation according to the invention. In this case, the finish formulation, which contains a dispersant, activated particles dispersed therein with hydrophobic and/or oleophobic surface groups and a binder, is applied to the surface of an object and then dried and/or hardened. The finish formulation according to the invention is suitable for transparent finishes.

All conventional application methods are suitable for applying the finish formulation, wherein the type of surface to be finished must be taken into account. For example, one suitable application process involves impregnation or coating. Examples of conventional application processes include immersion, rolling, doctoring, fluting, soaking, padding, spraying, spinning or brushing.

After applied, the finish formulation is dried and/or hardened, in order to obtain the hydrophobic and/or oleophobic finish on the surface of the object. Drying can take place by partially or completely removing the dispersant, usually via simple evaporation of the dispersant. Drying can be supported by elevated temperatures, an air stream and/or diminished pressure, for example. If necessary, drying already yields the completed, hardened finish.

The applied formulation is preferably hardened after drying, or possibly without drying beforehand. Hardening can also be performed according to the usual procedures, e.g., via heating and/or actinic radiation. During this hardening step, the aforementioned functional groups contained in the finish formulation can be subjected to polymerization, condensation or cross-linking reactions, which in addition to hardening the finish, can also improve adhesion to the surface to be treated.

The particles with hydrophobic and/or oleophobic surface groups are preferably bonded with the finish, enriched on the surface of the finish or at the substrate/finish interface, or aligned inside the finish or at the substrate/finish interface.

The invention will be explained in greater detail in the following examples. The used Pluronic® products are here PO/EC) block polymers that are used as nonionic surfactants. Nano-protec-com® from Schoeller Textil AG is a dispersion consisting of nonionic or cationic fluoropolymers and a nonionic or cationic oxime-blocked polyisocyanate as the extender, which is used as the binding phase. Lyofix® MLF is a nonionic alkyl-modified melamine/formaldehyde derivative. Citric acid is used for pH regulation and as catalyst. Bermocoll® is a cellulose ether.

### EXAMPLES

### Example 1

### Manufacture of Activated Particle Dispersions

### Example 1.1

### Manufacture of Activated Particle Dispersion 1.1

Perfluorinated silica (C-5 perfluorinated) is added to a solution of Pluronic PE 6200, Pluronic PE 6800 in 2-propanol and butyl glycol whiles stirring. Mixing then takes place, first in VE water, and then in a homogeneous solution of Bermocoll E230 FQ (1%) in VE water. The dispersion is mechanically activated in an agitator ball mill under the following parameters.

### Activation Parameters:

Agitator ball mill: Drais PML, ZrO₂ grinding area cladding
Milling balls: diameter 1.75 mm, ZrO₂
Fill level: 75%
Throughput: 50 kg/h
Number of passes: 8

### Composition of Activated Particle Dispersion 1.1:

| | | |
|---|---|---|
| Perfluorinated silica | 63.2 | g |
| 2-propanol | 724 | g |
| Butyl glycol | 90 | g |
| Pluronic PE 6200 | 21.5 | |
| Pluronic PE 6800 | 5.4 | g |
| Bermocoll E230 FQ | 6 | g |
| VE water | 1065 | g |

### Example 1.2

### Manufacture of Activated Particle Dispersion 1.2

Particles of perfluorinated aluminum oxide (C6-perfluorinated) are added to a solution of Pluronic PE 6200, Pluronic PE 6800 in 2-propanol and butyl glycol while stirring, after which mixing takes place in a homogeneous solution of Bermocoll E230 FQ (0.66%) in VE water. The dispersion is mechanically activated in an agitator ball mill under the following parameters.

### Activation Parameters:

Agitator ball mill: Drais PML, ZrO₂ grinding area cladding
Milling balls: diameter 1.75 mm, ZrO₂
Fill level: 75%
Throughput: 50 kg/h
Number of passes: 8

### Composition of Activated Particle Dispersion 1.2:

| | | |
|---|---|---|
| Perfluorinated aluminum oxide | 42.5 | g |
| 2-propanol | 454 | g |
| Butyl glycol | 38 | g |
| Pluronic PE 6200 | 9.2 | g |
| Pluronic PE 6800 | 2.2 | g |
| Bermocoll E230 FQ | 3 | g |
| VE water | 452 | g |

### Example 1.2

### Manufacture of Activated Particle Dispersion 1.3

Aerosil® 200 surface-modified with aminoalkyl and perfluorinated groups is added to a solution of Pluronic PE 6200, Pluronic PE 6800 in 2-propanol and butyl glycol while stirring, after which it is mixed in a homogeneous solution of Bermocoll E230 FQ in VE water. The dispersion is mechanically activated in an agitator ball mill under the following parameters.

### Activation Parameters:

Agitator ball mill: Drais PML, ZrO₂ grinding area cladding
Milling balls: diameter 1.75 mm, ZrO₂
Fill level: 75%
Throughput: 55 kg/h
Number of passes: 8

### Composition of Activated Particle Dispersion 1.3:

| | | |
|---|---|---|
| Aminoalkyl/C6 perfluorinated Aerosil | 50.1 | g |
| 200 | | |
| 2-propanol | 474.5 | g |
| Butyl glycol | 44.6 | g |
| Pluronic PE 6200 | 10.7 | g |
| Pluronic PE 6800 | 2.7 | |
| Bermocoll E230 FQ | 3 | g |
| VE water | 414.5 | g |

### Example 2

### Manufacture of Finish Formulations

### Example 2.1

### Manufacture of Finish Formulations 2.1

### Example 2.1.1

### For Synthetic Fabric

The activated particle dispersion is mixed with Tween® 20, Schoeller Nano-protec-com (Schoeller Textil AG, Switzerland), 2-propanol, citric acid and water while stirring, and then homogenized with an emulsifying pump.

### Composition of Finish Composition 2.1.1.

| | | |
|---|---|---|
| Activated particle dispersion 1.1 | 62.5 | g |
| Tween 20 | 1.5 | g |
| 2-propanol | 10 | g |
| Schoeller Nano-protec-com | 72 | g |
| Aqueous citric acid | 0.3 | g |
| Water | 833.7 | g |

### Example 2.1.2

### For Natural Fabric

The activated particle dispersion is mixed with Tween 20, Scholler Nano-protec-com, 2-propanol, citric acid, Lyofix MLF (Huntsman) and water while stirring, and then homogenized with an emulsifying pump.

### Composition of Finish Composition 2.1.2.

| | | |
|---|---|---|
| Activated particle dispersion 1.1 | 62.5 | g |
| Tween 20 | 1.5 | g |
| Schoeller Nano-protec-com | 72 | g |
| 2-propanol | 10 | g |
| Aqueous citric acid | 0.3 | g |
| Water | 833.7 | g |
| Lyofix MLF | 20 | g |

### Examples 2.2.1, 2.2.2 and 2.3.1 and 2.3.2

The same procedure as in 2.1.1 and 2.1.2 is followed, except that the respective corresponding particle dispersion 1.2 and 1.3 is used instead of the activated particle dispersion 1.1.

### Composition of Finish Formulation 2.2.1.

| | | |
|---|---|---|
| Activated particle dispersion 1.2 | 11.75 | g |
| Tween 20 | 1.5 | g |
| Schoeller Nano-protec-com | 72 | g |
| 2-propanol | 10 | g |
| Aqueous citric acid | 0.3 | g |
| Water | 884.45 | g |

### Composition of Finish Formulation 2.2.2.

| | | |
|---|---|---|
| Activated particle dispersion 1.2 | 11.75 | g |
| Tween 20 | 1.5 | g |
| Schoeller Nano-protec-com | 72 | g |
| 2-propanol | 10 | g |
| Aqueous citric acid | 0.3 | g |
| Water | 884.45 | g |
| Lyofix MLF | 20 | g |

### Composition of Finish Formulation 2.3.1.

| | | |
|---|---|---|
| Activated particle dispersion 1.3 | 20 | g |
| Tween 20 | 1.5 | g |
| Schoeller Nano-protec-com | 72 | g |
| 2-propanol | 10 | g |
| Aqueous citric acid | 0.3 | g |
| Water | 876.20 | g |

### Composition of Finish Formulation 2.3.2.

| | | |
|---|---|---|
| Activated particle dispersion 1.3 | 20 | g |
| Tween 20 | 1.5 | g |
| Schoeller Nano-protec-com | 72 | g |
| 2-propanol | 10 | g |
| Aqueous citric acid | 0.3 | g |
| Water | 876.20 | g |
| Lyofix MLF | 20 | g |

### Example 3

### Finishing of Substrates

### Example 3.1.1

### Finishing of Polyamide Substrates

A polyamide fabric with a weight per unit area of 120 g/m² is applied to a foulard with the finish formulation 2.1.1. The contact pressure of the rolls measures 15 bar, resulting in a formulation absorption of 62%. The application rate measures 1.5 m/min. The material is padded twice (0.75 m/min). The treated polyamide fabric is then dried in circulating air at 140° C. for 150 s, and subsequently condensed at 170° for 45 s. This yields the polyamide fabric 3.1.1 finished according to the invention.

### Example 3.1.2

### Finishing of Cotton Substrates

A cotton fabric with a weight per unit area of 150 g/m² is applied to a foulard with the finish formulation 2.1.2. The contact pressure of the rolls measures 15 bar, resulting in a formulation absorption of 65%. The application rate measures 1.5 m/min. The material is padded twice (0.75 m/min). The treated cotton fabric is then dried in circulating air at 140° C. for 150 s, and subsequently condensed at 170° C. for 45 s. This yields the cotton fabric 3.1.2 finished according to the invention.

### Examples 3.2.1, 3.2.2, 3.3.1 and 3.3.2

The same procedure as in 3.1.1 and 3.1.2 is followed, except that the respective corresponding finish formulation 2.2.1 and 2.2.2 or corresponding finish formulation 2.3.1 and 2.3.2 are used instead of the finish formulation 2.1.1 and finish formulation 2.1.2. This yields the fabric 3.2.1, 3.2.2, 3.3.1 and 3.3.2 finished according to the invention.

### Comparative Example

A non-activated particle dispersion 1.4 is fabricated, wherein the process is similar to 1.1, except that no activation is performed in the agitator ball mill, and the corresponding finish formulations 2.4.1 and 2.4.2 are analogous to 2.1.1 and 2.1.2, and finished fabric 3.4.1 and 3.4.2 are analogous to 3.1.1 and 3.1.2.

### Bundesmann Rain Test DIN 53888

A specimen with a diameter of 14 cm is exposed to rain for 10 min. Beading and drop patterns are assessed after 1 min., 5 min. and 10 min. The best grade is 5 the worst 1. Water absorption is determined by weighing.

### Oil Test AATCC 118

Oils were applied to 8 different test specimens, and evaluated after 30 s. The drop is intended to form a bead, and not dampen. Grading scale 1 (worst) to 8.

### Martindale Abrasion

Per SN 198529 load: 9 kPa
100 drying+condensing cycles.

A specimen with a diameter of 14 cm is clamped with a dry felt and abraded with a wool fabric for 100 cycles.

The PA specimen is condensed at 120° C. for 1 min.

The CO specimen is condensed at 170° C. for 1 min.

The Bundesmann rain test is then performed.

100 wet+condensing cycles.

A specimen with a diameter of 14 cm is clamped with a wet (immersed in soft water for 1 min.) felt and abraded with a wool fabric for 100 cycles. Dry at room temperature for 24 hours.

The PA specimen is condensed at 120° C. for 1 min.

The CO specimen is condensed at 170° C. for 1 min.

The Bundesmann rain test is then performed.

### Washing per ISO 6330

Test values for the textile samples according to the invention as well as the comparison sample

| | Beading grade, | | | Beading grade after 100 | | | Beading grade after 100 | | | Beading grade washed | | |
|---|---|---|---|---|---|---|---|---|---|---|---|---|
| | original | | | cycles dry + cond | | | cycles wet + cond | | | 5× at 40° C. | | |
| Textile | 1 | 5 | 10 | 1 | 5 | 10 | 1 | 5 | 10 | 1 | 5 | 10 |
| sample | min | min | min | min | min | min | min | min | min | min | min | min |
| 3.1.1 | 5 | 5 | 5 | 5 | 5 | 5 | 5 | 5 | 5 | 4 | 4 | 4 |
| 3.1.2 | 5 | 5 | 5 | 5 | 4 | 4 | 5 | 4 | 4 | 5 | 5 | 4 |
| 3.2.1 | 5 | 5 | 5 | 5 | 5 | 5 | 5 | 5 | 5 | 5 | 5 | 5 |
| 3.2.2 | 5 | 5 | 5 | 5 | 5 | 5 | 5 | 5 | 5 | 5 | 5 | 5 |
| 3.3.1 | 5 | 5 | 5 | 5 | 5 | 5 | 5 | 5 | 5 | 5 | 5 | 5 |
| 3.3.2 | 5 | 5 | 5 | 5 | 5 | 5 | 5 | 5 | 5 | 5 | 5 | 5 |
| 3.4.1 | 5 | 4 | 4 | 4 | 3 | 3 | 5 | 4 | 3 | 3 | 3 | 2 |
| (comparison) | | | | | | | | | | | | |
| 3.4.2 | 5 | 5 | 5 | 4 | 2 | 2 | 5 | 2 | 2 | 4 | 3 | 2 |
| (comparison) | | | | | | | | | | | | |

The finish formulations according to the invention exhibit a clearly improved durability of the finish relative to the comparative examples (3.4.1 and 3.4.2) in which the particles were not activated via comminuting.

1-36. (canceled)

37. A method for manufacturing a finish formulation for the hydrophobic and/or oleophobic finishing of surfaces, which comprises a dispersant, activated particles with hydrophobic and/or oleophobic surface groups dispersed therein, and a binder, the method comprising steps of
comminuting said particles with hydrophobic and/or oleophobic surface groups in the dispersant for activation; and
adding the binder to the formulation before or after the step of comminuting the said particles.

38. The method according to claim 37, wherein the particles are mechanically comminuted.

39. The method according to claim 37, wherein the particles are comminuted via shearing and/or impact.

40. The method according to claim 37, wherein the particles are comminuted in a dispersing machine.

41. The method according to claim 37, wherein the particles are comminuted via wet milling in a mill with auxiliary grinding units, in a roll mill with at least one roll nip, or in an impingement air dispenser.

42. The method according to claim 37, wherein the dispersant is water and/or an organic solvent.

43. The method according to claim 37, wherein comminuting takes place in a ball mill by introducing at least 50 kWh of energy per 1000 kg of finish formulation.

44. The method according to claims 37, wherein the dispersant is simultaneously the binder.

45. The method according to claim 37, wherein the binder comprises an organic monomer, oligomer, prepolymer and/or polymer or their emulsions or dispersions, wherein the binder can be a combination of several binders.

46. The method according to claim 37, wherein the binder comprises hydrolysable compounds or an inorganic or organically modified inorganic hydrolyzate or condensate of the hydrolysable compounds.

47. The method according to claim 37, wherein the binder comprises functional groups that enable polymerization, condensation or cross-linking reactions.

48. The method according to claim 37, wherein at least one additive is added to or contained in the mixture of particles and the dispersant, selected from wetting agents, thickeners, dispersants, initiators, catalysts, IR and UV protectants, coupling agents, softeners, antistatic agents, biocides, flame retardants, dyes, optical brighteners, anti-slip agents, anti-snag agents, laminating agents, nanoparticles, microparticles, carbon nanotubes.

49. The method according to claim 37, wherein the particles with hydrophobic and/or oleophobic surface groups are inorganic particles, the surface of which is modified with hydrophobic and/or oleophobic groups.

50. The method according to claim 49, wherein the inorganic particles are metal or semi-metal oxide particles or mixtures thereof.

51. The method according to claim 50, wherein the metal or semi-metal oxide is selected from the group consisting of silicon oxide, aluminum oxide, zirconium oxide, titanium oxide, vanadium oxide, tungsten oxide, iron oxide and zinc oxide.

52. The method according to claim 37, wherein the hydrophobic and/or oleophobic surface groups of the particles comprise organic, fluorine-containing groups and/or alkyl groups.

53. The method according to claim 52, wherein the organic, fluorine-containing group is a fluoroalkyl group or perfluoroalkyl group.

54. The method according to claim 37, wherein the particles comprise at least one other surface group in addition to the hydrophobic and/or oleophobic surface groups.

55. The method according to claim 54, wherein the other surface group comprises a functional group that enables polymerization, condensation or cross-linking reactions.

56. The method according to claim 37, wherein the particles with hydrophobic and/or oleophobic surface groups have a specific surface of between 10 and 1,000 m²/g after activation.

57. The method according to claim 37, wherein the concentration of activated particles with hydrophobic and/or oleophobic surface groups in the finish formulation ranges from 0.001 to 50 wt. % relative to the total weight of the finish formulation.

58. A finish formulation for hydrophobic and/or oleophobic finishing of surfaces, which comprises a dispersant, activated fragments with hydrophobic and/or oleophobic surface groups dispersed therein, and a binder.

59. A finish formulation for hydrophobic and/or oleophobic finishing of surfaces according to claim 58, obtained by steps of
activating particles having hydrophobic and/or oleophobic surface groups by comminuting said particles in a dispersant; and
adding a binder to the formulation before or after the comminuting step.

60. A method of hydrophobic and/or oleophobic finishing of surfaces, comprising a step of applying a finish formulation according to claim 59 onto said surface.

61. The method according to claim 60, wherein the surface is selected from fibers, textiles, glass, ceramic, metal, wood, plastic, or mixtures thereof.

62. The method of claim 60, wherein the finish formulation is dried and/or hardened after being applied.

63. The method according to claim 62, wherein the particles with hydrophobic and/or oleophobic surface groups are bound to the binder or substrate surface.

64. The method according to claim 60, wherein the particles with hydrophobic and/or oleophobic surface groups are enriched at the finish/outside environment interface or at the substrate/finish interface.

65. The method according to one of claims 62, wherein particles with hydrophobic and/or oleophobic surface groups are aligned in the matrix of the binder or at the substrate/finish interface.

66. The method according to claim 60, wherein the surface of the object is pretreated prior to application of the finish formulation via the application of a primer, treatment with acid or lye, plasma treatment, corona treatment, plasma oxidation and/or plasma polymerization.

67. An object with a surface that is finished with a hydrophobic and/or oleophobic finish obtained from a finish formulation according to claim 59.

68. The object according to claim 67, wherein the finish is transparent.

69. The object according to claim 67, wherein the object or its surface is a fiber, textile, glass, ceramic, metal, wood, plastic, or mixtures thereof.
